(19) United States
(12) Patent Application Publication
(10) Pub. No.: US 2001/0019233 A1
(43) Pub. Date: Sep. 6, 2001

(54) Lateral pressure mechanism for driving shaft of motor

(76) Inventors: Nobuyuki Nakagome, Tokyo (JP); Hitoshi Kobayashi, Tokyo (JP)

Correspondence Address: McGuire Woods, Suite 1800, Tysons Corner, 1750 Tysons Boulevard, McLean, VA, 22102-3915, US

(21) Appl. No.: 09/771,925

(22) Filed: Jan. 30, 2001

(30) Foreign Application Priority Data
Jan. 31, 2000 (JP) P2000-021690

(51) Int. Cl. H02K 5/16; H02K 7/08

(52) U.S. Cl. 310/90

(57) ABSTRACT

A bearing member 13 is provided on a main body 12 of a motor 10 so as to support a base end portion of a driving shaft 11. A cylindrical holder 23 is integrally formed with the main body so as to surround the bearing member. A lateral bearing member 21 is disposed in the cylindrical holder so as to adjacent to the bearing member on a side of a distal end of the driving shaft to laterally support the driving shaft. A spring member 22 is disposed in the cylindrical holder so as to extend along an inner peripheral face of the cylindrical holder and such that one tip portion thereof urges a part of an outer peripheral face of the lateral bearing member in a direction perpendicular to the driving shaft.

### BACKGROUND OF THE INVENTION

The present invention relates to a lateral pressure mechanism for suppressing vibrating noise of a driving shaft of such as a spindle motor or the like.

In CD, DVD, and other similar players, for example, a spindle motor for rotatively driving a CD, a DVD, or the like has a very small gap (clearance) between a driving shaft of the motor and a bearing. Consequently, the driving shaft vibrates in conjunction with the rotation of the driving shaft, and the so-called clearance noise occurs.

For this reason, a lateral pressure mechanism is adopted for suppressing the vibration of the driving shaft is adopted by urging the driving shaft from a lateral direction.

The above-described lateral pressure mechanism is constructed as shown in FIGS. 4 and 5.

Namely, in FIGS. 4 and 5, a spindle motor 1 is fixed and held in a mounting plate 2 of various equipment such as a CD player, a DVD player, or the like by an appropriate member (not shown ) such as press-fitting, such that its driving shaft 3 is passed through a mounting hole 2a provided in the mounting plate 2.

Here, the aforementioned driving shaft 3 is rotatably supported in a main body 1a of the motor 1 by means of a bearing 4.

In addition, a lateral pressure mechanism 5 is provided for the driving shaft 3 of the spindle motor 1.

The lateral pressure mechanism 5 is comprised of a lateral bearing 5a fitted over the driving shaft 3 and a spring 5b for pressing the bearing 5a in a direction perpendicular to the axial direction of the driving shaft 3.

As both ends of the spring 5b are respectively engaged with a pair of projections 2b embedded on the mounting plate 2, the spring 5b is adapted to press a side face of the bearing 5a in a deflected state, as shown in FIG. 5.

According to the lateral pressure mechanism 5 thus constructed, when the driving shaft 3 rotates during the operation of the spindle motor 1, even if the driving shaft 3 tends to vibrate inside the bearing 4 due to the clearance with the bearing 4, since the driving shaft 3 is pressed laterally by the spring 5b through the lateral bearing 5a, the driving shaft 3 is urged inside the bearing 4. Accordingly, the aforementioned vibration can be suppressed, thereby preventing the occurrence of the clearance noise.

However, in the lateral pressure mechanism 5 having the above-described construction, the spring 5b is held by the projections 2b embedded on the mounting plate 2. For this reason, there have been problems in that, depending on cases, it is impossible to secure a space for disposing the projections 2b on the mounting plate 2, that the spring 5b needs to be incorporated after mounting the spindle motor 1 on the mounting plate 2, which makes the assembling operation complicated, and that the mounting space becomes large since the spring 5b extends out substantially in the direction perpendicular to the driving shaft 3.

### SUMMARY OF THE INVENTION

In view of the above-described aspects, an object of the invention is to provide a lateral pressure mechanism for a motor driving shaft which can be constructed simply and compactly and does not limit the place where the motor is mounted.

In order to achieve the above object, according to the present invention, there is provided a motor comprising:

a main body provided with a driving shaft;

a bearing member provided on the main body so as to support a base end portion of the driving shaft;

a cylindrical holder integrally formed with the main body so as to surround the bearing member;

a lateral bearing member disposed in the cylindrical holder so as to adjacent to the bearing member on a side of a distal end of the driving shaft to laterally support the driving shaft; and

a spring member disposed in the cylindrical holder so as to extend along an inner peripheral face of the cylindrical holder and such that one tip portion thereof urges a part of an outer peripheral face of the lateral bearing member in a direction perpendicular to the driving shaft.

In this construction, even if the driving shaft of the motor tends to vibrate with respect to the bearing member when the driving shaft of the motor rotates, since the driving shaft of the motor is urged toward one side by the spring member, the vibration can be suppressed, thereby making it possible to prevent the occurrence of the so-called clearance noise.

In this case, since the spring member is disposed between the outer peripheral face of the lateral bearing member and the inner face of the cylindrical holder, the spring member is completely incorporated in the motor.

Accordingly, the lateral pressure mechanism can be provided on the motor at any place insofar as the place allows the motor to be mounted, so that the limitation of the mounting place in the lateral pressure mechanism in which the spring extends out to the outside can be eliminated, thereby making it possible to reduce the mounting space.

Preferably, an end portion of the lateral bearing member facing the distal end side of the driving shaft is made smaller in diameter to form a stepped portion to which the tip portion of the spring member engages.

In this construction, the lateral bearing member can be reliably urged laterally, and the lateral bearing member can be prevented from coming off in the distal end side of the driving shaft.

Preferably, the spring member is formed into a shape like a character “e” viewed from an axial direction of the driving shaft.

Preferably, the spring member is fixed on the inner peripheral face of the cylindrical holder by at least one caulking member.

In this construction, the spring member can be prevented from coming off the cylindrical holder.

### BRIEF DESCRIPTION OF THE DRAWINGS

In the accompanying drawings:

FIG. 1 is a schematic cross-sectional view illustrating the construction of a spindle motor incorporating a lateral pressure mechanism according to an embodiment of the invention;

FIG. 2 is a partial enlarged cross-sectional view illustrating essential portions of the spindle motor shown in FIG. 1;

FIG. 3 is a partial enlarged plan view illustrating the essential portions of the spindle motor shown in FIG. 1;

FIG. 4 is a schematic cross-sectional view illustrating a related spindle motor having a lateral pressure mechanism; and

FIG. 5 is a plan view of the motor shown in FIG. 4.

### DETAILED DESCRIPTION OF THE PREFERRED EMBODIMENTS

Hereafter, a more detailed description will be given of the invention on the basis of an embodiment illustrated in the drawings.

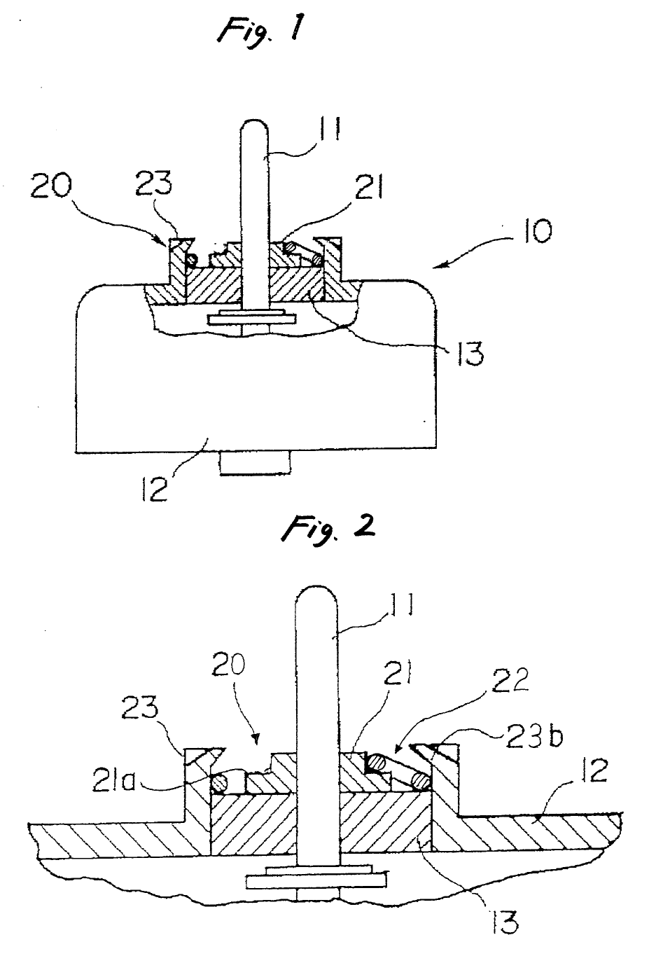

FIG. 1 illustrates the construction of a spindle motor incorporating a lateral pressure mechanism according to an embodiment of the invention.

In FIG. 1, a spindle motor 10 is a spindle motor which is used for such as a CD player, a DVD player, or the like, its driving shaft 11 is rotatably supported in a main body 12 of the motor by means of a bearing 13, and a lateral pressure mechanism 20 is provided for the driving shaft 11.

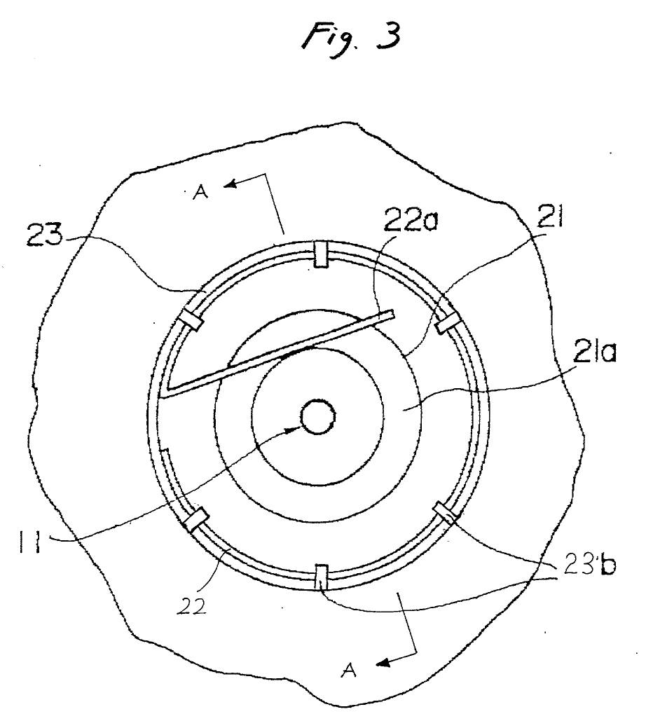

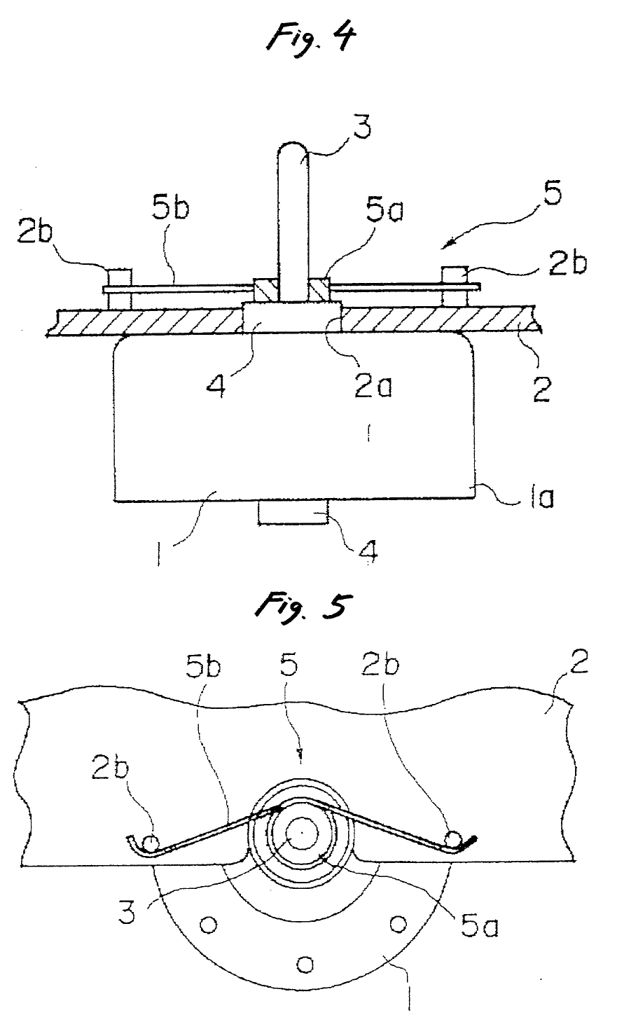

As shown in FIGS. 2 and 3, the lateral pressure mechanism 20 is comprised of a lateral bearing 21 fitted over the driving shaft 11 and a spring 22 for pressing the bearing 21 in a direction perpendicular to the axial direction of the driving shaft 11.

The lateral bearing 21 is placed adjacent to the bearing 13 on a side of a distal end of the driving shaft 11 inside a bearing holder 23 formed in such a manner as to surround the bearing 13.

Here, the bearing holder 23 is formed in a hollow cylindrical shape, extends in parallel with the driving shaft 11, and is formed integrally with the main body 12 of the motor.

In addition, a portion of the lateral bearing 21 facing the distal end of the driving shaft 11 is made smaller in diameter to form a stepped portion 21a.

The spring 22 is formed substantially in the shape of reversed “e” in a top plan view as shown in FIG. 3, and extends in the circumferential direction between the inner face of the bearing holder 23 and an outer peripheral face of the lateral bearing 21 along the inner face of the bearing holder 23. A tip 22a of the spring 22 abuts against the stepped portion 21a of the lateral bearing 21.

As a result, the spring 22 is so arranged that its tip portion 22a presses the lateral bearing 21 in a direction perpendicular to the axial direction.

Here, the spring 22 is fixed on the inner face of the bearing holder 23 by at least one caulking member 22b (in this embodiment, six members are provided).

It should be noted that it suffices if caulking 22b is provided at least one position since it is sufficient if the spring 22 is fixed reliably to the inner face of the bearing holder 23. Further, caulking may be provided over the entire length of the spring 22.

The spindle motor 10 having the lateral pressure mechanism in accordance with the embodiment of this invention is constructed as described above, and during the operation of the spindle motor 10, as a rotor (not shown) incorporated in the main body 12 of the motor is rotatively driven, the driving shaft 11 rotates inside the bearing 13.

At this time, even if the driving shaft 11 tends to vibrate inside the bearing 13 due to the clearance with the inner face of the bearing 13, since the driving shaft 11 is laterally pressed by the spring 22 through the lateral bearing 21, the driving shaft 11 is urged inside the bearing 13.

Accordingly, since the driving shaft 11 is laterally urged inside the bearing 13, the aforementioned vibration can be suppressed, thereby preventing the occurrence of the clearance noise.

In addition, since the lateral bearing 21 has the stepped portion 21a, the spring 22 reliably engages the lateral bearing 21 and is capable of pressing the same in the lateral direction, and the lateral bearing 21 can be prevented from coming off in the distal end side of the driving shaft 11 by virtue of the spring 22.

Although, in the above-described embodiment, a description has been given of the case in which the lateral pressure mechanism is incorporated in the spindle motor 1, the invention is not limited to the same, and it is evident that the invention can be applied to a lateral pressure mechanism incorporated in a motor of another type, e.g., a compact DC motor or the like.

In addition, although, in the above-described embodiment, the lateral bearing 21 has the stepped portion 21a, this stepped portion 21a may be omitted. In this case, the tip portion 22a of the spring 22 abuts against the outer peripheral face of the lateral bearing 21.

Further, although, in the above-described embodiment, the spring 22 is formed substantially in the reversed “e” shape in the top plan view, the invention is not limited to the same, and it is sufficient if the shape allows the spring 22 to be fixed and held onto the inner face of the bearing holder 23 and abut against the stepped portion 21a or the outer peripheral face of the lateral bearing 21.

As described above, in accordance with the invention, even if the driving shaft of the motor tends to vibrate with respect to the bearing when the driving shaft of the motor rotates, since the driving shaft of the motor is urged toward one side by the spring, the vibration can be suppressed, thereby making it possible to prevent the occurrence of the clearance noise.

In this case, since the spring is disposed between a part of the outer peripheral face of the lateral bearing and the inner face of the bearing holder, the spring is completely incorporated in the motor.

Accordingly, the lateral pressure mechanism can be provided on the motor at any place insofar as the place allows the motor to be mounted, so that the limitation of the mounting place in the lateral pressure mechanism in which the spring extends out to the outside can be eliminated, thereby making it possible to reduce the mounting space.

As such, in accordance with the invention, it is possible to provide an extremely outstanding lateral pressure mechanism for a motor driving shaft which can be constructed simply and compactly and does not limit the place where the motor is mounted.

What is claimed is:

1. A motor comprising:
a main body provided with a driving shaft;
a bearing member provided on the main body so as to support a base end portion of the driving shaft;
a cylindrical holder integrally formed with the main body so as to surround the bearing member;
a lateral bearing member disposed in the cylindrical holder so as to adjacent to the bearing member on a side of a distal end of the driving shaft to laterally support the driving shaft; and
a spring member disposed in the cylindrical holder so as to extend along an inner peripheral face of the cylindrical holder and such that one tip portion thereof urges a part of an outer peripheral face of the lateral bearing member in a direction perpendicular to the driving shaft.

2. The motor as set forth in claim 1, wherein an end portion of the lateral bearing member facing the distal end side of the driving shaft is made smaller in diameter to form a stepped portion to which the tip portion of the spring member engages.

3. The motor as set forth in claim 1, wherein the spring member is formed into a shape like a character “e” viewed from an axial direction of the driving shaft.

4. The motor as set forth in claim 1, wherein the spring member is fixed on the inner peripheral face of the cylindrical holder by at least one caulking member.
